(19) United States
(12) Patent Application Publication
(10) Pub. No.: US 2005/0155076 A1
(43) Pub. Date: Jul. 14, 2005

(54) Data IO device

(76) Inventors: Okihisa Utsumi, Kobe-shi (JP); Kazuhiko Yamashita, Soraku-gun (JP); Takashi Kodera, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/017,886

(22) Filed: Dec. 22, 2004

(30) Foreign Application Priority Data
Dec. 26, 2003 (JP) 2003-433104

(51) Int. Cl. H04N 7/173

(52) U.S. Cl. 725/105

(57) ABSTRACT

A data IO device acquires stream data that includes CCI (copy control information) and outputs the stream data after finalizing a content of the CCI. Specifically, the data IO device sequentially acquires stream data including CCI, judges whether all stream data acquired within a predetermined time period includes the same CCI, and processes all stream data acquired during the predetermined time period in accordance with the same copy control information if judged in the affirmative.

### BACKGROUND OF THE INVENTION

1. Field of the Invention

The present invention relates to a data IO (input/output) device that acquires stream data to which CCI (copy control information) is appended and outputs the acquired stream data after correcting for changes in the CCI resulting from disturbance.

2. Related Art

Digital broadcasts are now being implemented that include CCI that indicates whether a digital broadcast can be recorded or copied. Household devices such as video recorders and DVD recorders are setup to read the CCI and judge whether recording or copying of the digital broadcast is permissible.

Copy control technology, which plays an important role in the copyright protection of contents, is realized, for example, by appending information that indicates COPY NEVER if “00”, COPY ONCE if “01” and COPY FREELY if “11”, and performing copy controls to rewrite the CCI to “00” after recording the digital broadcast if the appended CCI is “01”, and to prohibit copying if the CCI is “00”.

However, the value of CCI appended to a digital broadcast can change due to weather conditions such as rainstorms and the like not anticipated by broadcast standards, meaning for example that received content which was only for copying once may become freely copyable due to a change in the CCI. In this case, problems arise in terms of copyright protection and the like because of being unable to inhibit consumers from widely circulating contents contrary to the intent of the broadcast distributor. With situations such as this in mind, those involved in the distribution of broadcasts are looking to prevent changes in CCI.

### SUMMARY OF THE INVENTION

In view of the above problem, the present invention aims to provide a data IO device capable of correcting for changes in CCI due to unanticipated weather conditions and the like, and thereby increasing the reliability of CCI.

To resolve the above problem, a data IO device pertaining to the present invention acquires stream data that includes CCI and outputs the stream data after finalizing a content of the CCI. To achieve this the data IO device includes an acquiring unit operable to sequentially acquire stream data that includes CCI, a sameness judging unit operable to judge whether all stream data acquired within a predetermined time period includes a same CCI, and a processing unit operable, if the sameness judging unit judges in the affirmative, to process all stream data acquired during the predetermined time period in accordance with the same CCI.

With this structure the reliability of CCI within the predetermined time period can be improved. Conventionally, DVD recorders and the like simply performed recording in accordance with CCI included in received stream data. With the above structure, however, it is possible, by performing a deviation judgment, to finalize the CCI of stream data acquired within a predetermined time period and execute stream data processing. Here, the deviation judgment involves judging whether the CCI of stream data acquired within a predetermined time period (“deviation judgment period”) is the same. The processing of stream data here involves both the outputting of stream data in a compatible format to an output target device for recording or the like, and the prohibiting of stream data recording or the like, depending on the value of the finalized CCI. Here, the processing unit is able to perform the outputting of stream data. When outputting is performed, the CCI value is changed if necessary and the changed CCI outputted to the output target of the stream data.

Here, if judged during the predetermined judgment period that CCI included in an n^{th} piece of acquired stream data differs from CCI included in an n−1^{th} piece of acquired stream data, the sameness judging unit may restart the sameness judgment from a point at which the negative judgment is made and judge whether stream data acquired from the n^{th} piece onward includes a same CCI.

With this structure, the starting point of the predetermined time period can be determined, and if the CCI of two consecutive pieces of stream data acquired within the predetermined time period are shown on comparison to differ, the sameness judgment can be restarted from the point at which the difference is detected.

Here, the data IO device may further include a difference judging unit operable, if the sameness judging unit judges in the affirmative, to judge whether stream data sequentially acquired after the stream data acquired within the predetermined time period includes CCI that differs from the same CCI, and the processing unit may continue to process, in accordance with the same CCI, stream data acquired after the sameness judging unit has judged in the affirmative, until a point at which the difference judging unit judges in the affirmative.

With this structure, stream data acquired subsequent to an end of the sameness judgment can be processed in accordance with the same CCI as that included in stream data acquired during the predetermined time period as long as the subsequent stream data includes this same CCI, thus allowing the load on the data IO device to be lightened since the predetermined time period need not be measured. This judgment as to whether the CCI of subsequent stream data is the same may also be included as part of the deviation judgment.

This processing can be applied because of the assumption that the value of CCI included in digital broadcasts and the like does not fluctuate over regular time periods known in advance (e.g., the 30 min. duration of a broadcast program etc.).

Here, the processing unit may process all stream data acquired from a start of the data acquisition until a point at which the sameness judging unit first judges that all stream data acquired during the predetermined time period includes the same CCI, in accordance with the same CCI.

This structure makes it possible to process stream data from the start of data acquisition until the point at which it is first judged that all stream data acquired within the predetermined period includes the same CCI.

Here, the sameness judging unit may newly judge, from the point at which the difference judging unit judges in the affirmative, whether all stream data acquired within the predetermined time period includes a same CCI, and the processing unit may process all stream data acquired from the point at which the difference judging unit judges in the affirmative until a point at which the sameness judging unit newly judges in the affirmative, in accordance with the same CCI.

With this structure, the judgment as to whether stream data acquired within the predetermined time period includes the same CCI can be newly performed if CCI fluctuates during the judgment performed by the difference judging unit, and all stream data acquired from the time of the fluctuation until the time at which it is again judged that all stream data acquired within the predetermined time period includes the same CCI can be processed using this same CCI.

For example, if CCI fluctuates momentarily during a digital broadcast program due to a rainstorm or similar disturbance, the fluctuation can be corrected for, to thus ensure that CCI included in stream data is uniform from the start to the end of the program, as intended by the party distributing the program.

Here, there may be plural types of stream data, the data IO device may further include a time-period storage unit storing a plurality of predetermined time periods in one-to-one correspondence with the types of stream data, and a time-period reading unit operable to read from the time-period storage unit a predetermined time period corresponding to the type of acquired stream data, and the sameness judging unit may judge, based on the type of acquired stream data, whether all stream data acquired within the predetermined time period read by the time-period reading unit includes a same CCI.

With this structure, the deviation judgment period can be determined according to the type of stream data acquired. The data IO device acquires a number of different types of stream data, including analog broadcasts, digital broadcasts and data read from DVD, with the length of the deviation judgment period for judging the sameness of CCI differing depending on the type of stream data. Judgment time periods for the different types of stream data that stand up to practical usage were obtained through experimentation using devices equivalent to the data IO device according to the present invention. These time periods are stored in the data IO device.

Here, there may be plural types of stream data, the data IO device may further include an initial-value storage unit storing a plurality of initial values for CCI in one-to-one correspondence with the types of stream data, and an initial-value reading unit operable to read from the initial-value storage unit an initial value corresponding to the type of acquired stream data, and the difference judging unit may further judge whether stream data sequentially acquired from a start of the data acquisition includes CCI that differs from the initial value.

With this structure an initial value of CCI can be assigned according to the type of stream data, and it can be judged whether the CCI of stream data acquired from the start of data acquisition deviates from the initial value.

In the present invention, the data IO device controls an output target device (e.g., DVD recorder) connected to the data IO device to tentatively record acquired stream data, and then when the CCI value has been finalized, the data IO device performs stream data processing in accordance with the finalized CCI. For example, if the finalized CCI indicates COPY NEVER, the data IO device has the output target device erase the recorded stream data. On the other hand, if the finalized CCI indicates COPY FREELY, the data IO device has the output target device include the CCI in the tentatively recorded stream data to confirm the recording. Note that because some output target devices will not record until the CCI has been confirmed, it is necessary in order to have stream data tentatively recorded to provisionally assigned an initial value for CCI to stream data when starting data acquisition.

Given that CCI included in digital broadcasts and the like indicates COPY ONCE in many cases, the difference judgment can be performed from the start of data acquisition by having the initial value stored as COPY ONCE. The need to measure the deviation judgment period from the start of data acquisition can thus be eliminated.

Here, the data IO device may further include an ID storage unit storing one or more input IDs in correspondence with the types of acquired stream data, and one or more output IDs in one-to-one correspondence with one or more output target devices to which stream data is to be outputted, a ID reading unit operable to read an input ID from the ID storage unit based on the type of acquired stream data, and an output ID corresponding to an output target device determined by a user input, and a path selection unit operable to select an output path for stream data, based on the read input ID and output ID.

With this structure, the data IO device is able, using input IDs and output IDs, to correctly select paths for stream data to pass over from input to output, and to thus transfer data as intended by the user.

Here, the processing performed by the processing unit may involve (i) controlling an output target device to record stream data with CCI indicating COPY FREELY included therein if the same CCI indicates COPY FREELY, (ii) controlling the output target device to record stream data with CCI changed to indicate COPY NEVER included therein if the same CCI indicates COPY ONCE, and (iii) prohibiting the output target device from recording stream data if the same CCI indicates COPY NEVER.

With this structure, the data IO device can change the CCI included in acquired stream data to COPY NEVER if finalized as COPY ONCE, while not changing the CCI if finalized as COPY FREELY or COPY NEVER. The data IO device is also able to control the output target device to erase tentatively recorded stream data in the case of the finalized CCI being COPY NEVER, while controlling the output target device to include in the tentatively recorded stream data, CCI indicating COPY FREELY in the case of the finalized CCI being COPY FREELY, and CCI indicating COPY NEVER in the case of the finalized CCI being COPY ONCE.

Here, a data IO method and computer program for acquiring stream data that includes CCI and outputting the stream data after finalizing a content of the CCI, include the steps of sequentially acquiring stream data that includes CCI, judging whether all stream data acquired within a predetermined time period includes a same CCI, and processing all stream data acquired during the predetermined time period in accordance with the same CCI, if judged in the affirmative.

With this method and computer program, it is possible to finalize the content of CCI included in stream data acquired within a predetermined time period.

### BRIEF DESCRIPTION OF THE DRAWINGS

These and other objects, advantages, and features of the invention will become apparent from the following description thereof taken in conjunction with the accompanying drawings, which illustrate specific embodiments of the present invention.

In the drawings:

FIG. 1 is a functional block diagram of a data IO device pertaining to the present invention;

FIG. 2A is correspondence table that associates inputted stream data with input IDs;

FIG. 2B is a correspondence table that associates output targets with output IDs;

FIG. 2C is a correspondence table that associates input sources with predetermined time periods for observing whether the CCI value fluctuates;

FIG. 3A is a correspondence table that associates input IDs with output IDs;

FIG. 3B is a CCI entry table used for judging CCI fluctuations;

FIG. 4 is a conversion table used in a conversion performed by a conversion unit when determining the CCI value of acquired stream data and appending the determined value to the stream data;

FIG. 5A is a graph illustrating the timing of a deviation judgment;

FIG. 5B is a graph showing the transition in CCI values after the fluctuating CCI values shown in FIG. 5A have been finalized;

FIG. 6 is a flowchart showing the operations of the data IO device; and

FIG. 7 is a flowchart showing processing by the data IO device that includes the deviation judgment.

### DETAILED DESCRIPTION OF THE PREFERRED EMBODIMENTS

A data IO (input/output) device pertaining to the present invention is described below while referring to the drawings.

Structure of Data IO Device

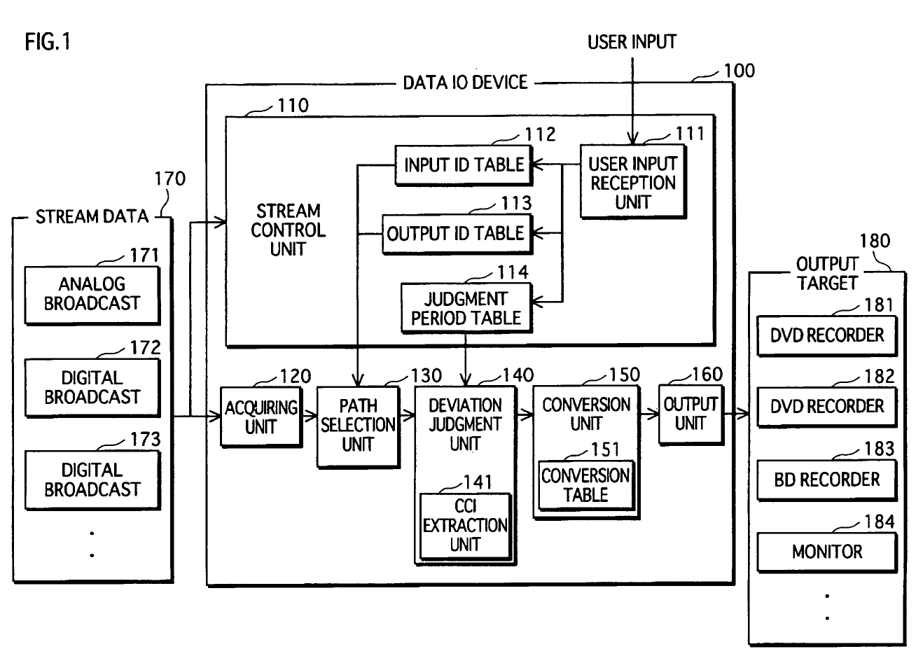

FIG. 1 is a functional block diagram of a data IO device 100 pertaining to the present invention.

Data IO device 100 is constituted to include a stream control unit 110, an acquiring unit 120, a path selection unit 130, a deviation judgment unit 140, a conversion unit 150, and an output unit 160. Data IO device 100 is actually a computer formed from a CPU (central processing unit), a ROM (read only memory), and a RAM (random access memory). By reading and executing computer programs included in ROM and holding required data sequentially in RAM, the CPU performs processing to acquire stream data, determine CCI (copy control information) values and output stream data to output target devices.

Stream control unit 110 functions to output input IDs relating to stream data acquired by data IO device 100, the output IDs of output target devices inputted by a user, and time periods used in a deviation judgment performed on acquired stream data. Unit 110 includes a user-input reception unit 111 for accepting user inputs in relation to inputted stream data, and stores an input ID table 112, an output ID table 113 and a judgment period table 114.

User inputs are performed using a remote controller, keyboard and the like while viewing a GUI (graphic user interface) displayed on a monitor.

Acquiring unit 120 functions to acquire stream data 170 that includes CCI from an external source. A number of different types of stream data are inputted to data IO unit 100, including analog broadcast 171, digital broadcast 172 and digital broadcast 173, for example. Although not depicted, stream data 170 also includes stream data such as that read from DVD by a DVD recorder.

Path selection unit 130 recognizes the connection status of devices connected to data IO device 100 as well as input IDs and output IDs related to these devices, and functions to establish (i.e., select), based on the input and output IDs outputted by stream control unit 110, the path along which inputted stream data is to travel on its way to the device or medium intended by the user. This enables data IO device 100 to output stream data to the device intended by the user.

Deviation judgment unit 140 includes a CCI extraction unit 141 that extracts CCI included in stream data acquired by acquiring unit 120.

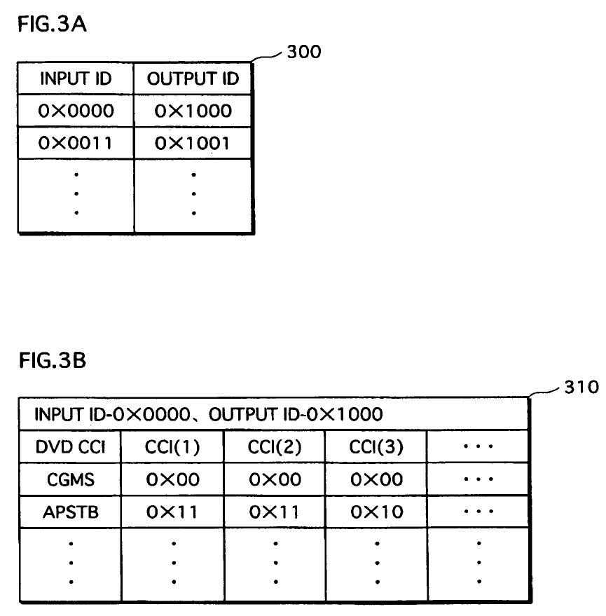

Deviation judgment unit 140 functions to judge whether the values of CCI extracted from stream data acquired within a deviation judgment period obtained from judgment period table 114 in stream control unit 110 are all the same. Unit 140 also functions to detect a change in the CCI of stream data acquired after the point at which all CCI values during the deviation judgment period have been judged to be the same. Unit 140 further functions to finalize the CCI value in the event that the CCI values of all stream data acquired during the deviation judgment period are judged to be the same. Specifically, unit 140 makes entries to and rewrites a deviation judgment table 310 such as shown in FIG. 3B, and monitors table 310 for changes in the CCI value during the deviation judgment period.

Deviation judgment unit 140 stores CCI initial values according to the different types of stream data, as the CCI values initially assigned to the final CCI values. The CCI initial values are set to a value that permits the recording of stream data. Here, a “final CCI value” is the value finalized as the CCI value of acquired stream data and applied as the legitimate CCI value of stream data acquired during a fixed time period or of all acquired stream data.

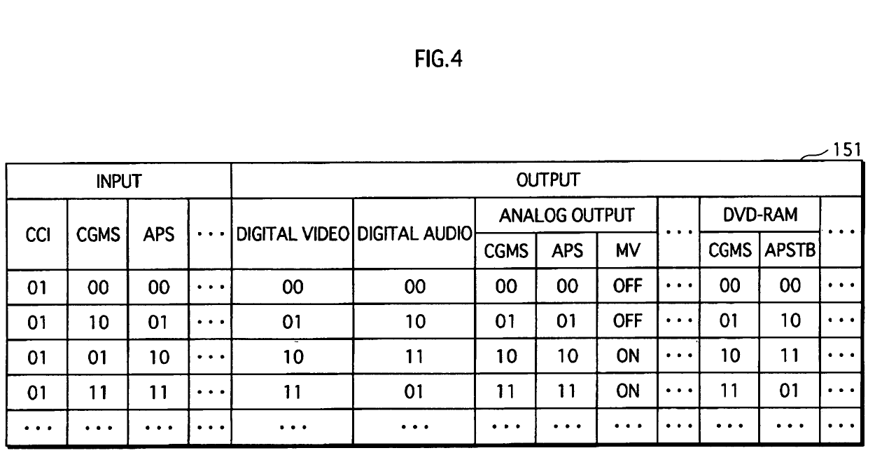

Conversion unit 150 stores a conversion table 151 as shown in FIG. 4, and functions to rewrite, based on conversion table 151, the value of CCI for including in stream data, after deviation judgment unit 140 has finalized the value of CCI included in stream data 170.

Conversion unit 150 also functions to convert stream data to a data format compatible with the output target device. This is performed using conventional conversion technology.

Output unit 160 functions to output stream data converted to a compatible data format to output target device 180 via a path established by path selection unit 130. Output target device 180 includes devices such as a DVD recorder 181, a DVD recorder 182, a BD recorder 183, and a monitor 184.

Note that in the present invention real-time recording of stream data cannot be performed while the deviation judgment is being performed because of the delay that arises as a result of the time taken to perform the judgment. In view of this, the technique adopted in the present invention is to initially output only the stream data (i.e. CCI not included) to the output target device and have the output target device tentatively record the outputted stream data. Then once the CCI has been finalized, data IO device 100 has the output target device erase the stream data if the CCI is finalized as COPY NEVER, while having the output target device include in the stream data to confirm the recording, CCI indicating COPY NEVER if the CCI is finalized as COPY ONCE, and CCI indicating COPY FREELY if the CCI is finalized as COPY FREELY.

Data Held by Data IO Device

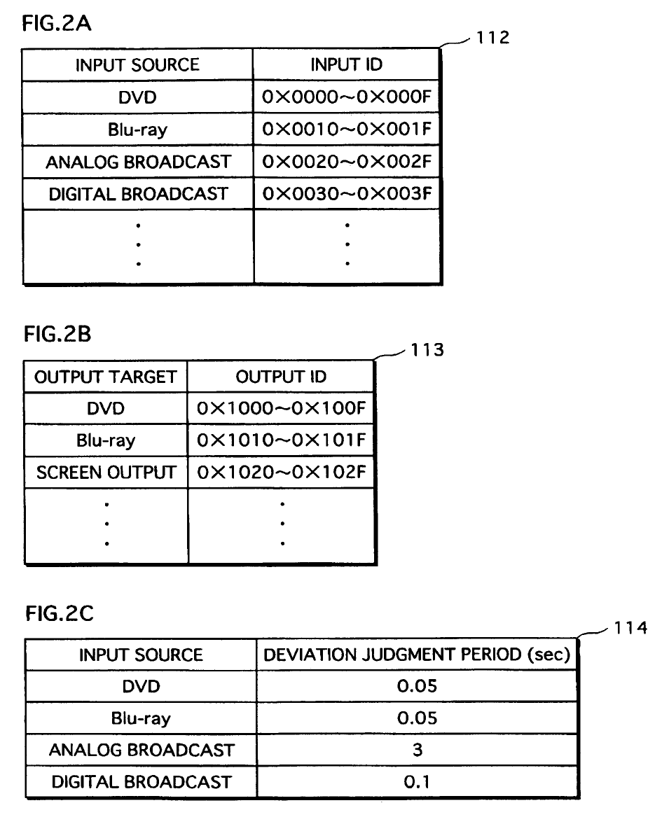

Data held by data IO device 100 is described next using FIGS. 2 to 4.

Firstly, input ID table 112 and output ID table 113 held by stream control unit 110 are described using FIGS. 2A and 2B.

FIG. 2A is an exemplary input ID table 112. As shown in the diagram, input IDs corresponding to the input source are allocated. For example, input IDs 0x0000-0x000F expressed in hexadecimal notation are allocated in the case of the input source being DVD. The setting of the input IDs to 0x0000-0x000F in the case of DVD assumes a maximum of 16 DVD players connected to data IO device 100 at any one time, with a different input ID being allocated to each input device. For example, the input ID 0x0031 is allocated to a tuner from which digital broadcast 172 is outputted. While the maximum number of input IDs is given here as 16, this figure can be changed arbitrarily by the user. The number of input IDs may be changed in line with the number of input devices connected to data IO device 100, and it is also possible to change individual input IDs.

Stream control unit 110 monitors the transmission origin of inputted stream data 170, reads the corresponding input ID from input ID table 112, and outputs the read input ID to path selection unit 130.

FIG. 2B is an exemplary output ID table 113. As shown in the diagram, output IDs corresponding to output targets are allocated. For example, output IDs 0x1000-0x100F expressed in hexadecimal notation are allocated in the case of the output target being DVD. The reason for the plurality of output IDs is the same as for the input IDs, with a different output ID being allocated to each output target device. For example, output IDs 0x1000 and 0x1001 are associated respectively with DVD recorders 181 and 182 shown in FIG. 1. While the maximum number of output IDs is given here as 16, this figure can be changed arbitrarily by the user. The number of output IDs may be changed to match the number of output devices connected to data IO device 100, and it is also possible to change individual output IDs.

When the output target device has been determined by user-input reception unit 111 as the result of a user input, stream control unit 110 reads the output ID corresponding to that device, and outputs the read output ID to path selection unit 130.

Input ID table 112 and output ID table 113 both need to be updated whenever a new device such as a DVD recorder is connected to data IO device 100. Stream control unit 110 may update tables 112 and 113 after path selection unit 130 has detected a change in the connection status of connected devices, or the user may update the tables manually via user-input reception unit 111.

FIG. 2C is an exemplary judgment period table 114 for determining deviation judgment periods used by deviation judgment unit 140 in finalizing CCI values. Because the time intervals between extracting CCI included in stream data acquired by acquiring unit 120 differ depending on the type of stream data, it is necessary to determine deviation judgment periods that vary depending on the type of stream data. Judgment period table 114 stores deviation judgment periods in association with the data content of the input source, as shown in FIG. 2C. For example, the deviation judgment period for analog broadcasts is 3 seconds.

In the case of a digital broadcast being acquired as stream data from an antenna, for example, stream control unit 110 reads that the deviation judgment period for digital broadcasts is 0.1 seconds, using judgment period table 114.

The following description relates to stream data passing over an output path determined by path selection unit 130, and to the tables used by deviation judgment unit 140 in the deviation judgment, with reference to FIGS. 3A and 3B.

Firstly, path selection unit 130 creates an output management table 300 as shown in FIG. 3A based on the input IDs and the output IDs. Output management table 300 is for managing stream data flowing along output paths in association with input and output IDs. Data IO device 100 simultaneously handles plural pieces of stream data, and unit 130 manages table 300 in order to prevent errors in the output target of individual pieces of stream data.

Deviation judgment unit 140 receives IO management table 300 from path selection unit 130, and creates a deviation judgment table 310 as shown in FIG. 3B for pieces of stream data relating to the same input ID and output ID. Unit 140 enters CCI values extracted by CCI extraction unit 141 such as CCI(1), CCI(2) and CCI(3) in FIG. 3B, and monitors table 310 for changes in the CCI value. There are only as many columns for entering CCI values as the number of CCI values to be acquired during the deviation judgment period. If a CCI value differing from the previous CCI value is entered, the CCI value entry columns are returned to a blank state, the different CCI value is transferred to CCI(1), and subsequent extracted values entered from CCI(2). If the same CCI value is entered in all of the entry columns when the deviation judgment period elapses, deviation judgment unit 140 judges that stream data having identical CCI values was acquired during the deviation judgment period. Deviation judgment table 310 is an exemplary table for stream data relating to the input ID 0x0000 and the output ID 0x1000. The recording of two types of CCI, namely CGMS (Copy Generation Management System) and APSTB (Analog Protection Single Trigger Bit), in deviation judgment table 310 is due to the fact that stream data may include more than one type of CCI.

In the given example, the CCI values of DVD stream data are stored in their extracted order as shown in deviation judgment table 310. Although the CGMS and APSTB values for CCI(1) and CCI(2) are respectively 0x00 and 0x11, the APSTB value changes to 0x10 at CCI(3) despite the CGMS value remaining unchanged at 0x00. The CCI value cannot be finalized in this case, so deviation judgment unit 140 carries on sequentially entering the CCI of subsequent stream data after firstly changing the CGMS and APSTB values for CCI(1) to 0x00 and 0x10, respectively. Here, if the APSTB value for CCI(3) was 0x11 and the deviation judgment period elapsed at the point at which the piece of stream data including CCI(3) was acquired, stream data processing would be executed at these CCI values (i.e., 0x00 and 0x11), as least in relation to the stream data including CCI(1), CCI(2) and CCI(3).

Conversion table 151 stored by conversion unit 150 is described next. FIG. 4 is an exemplary conversion table 151. Table 151 shows the correspondence between CCI values included in acquired stream data and the CCI values that data IO device 100 has included in stream data depending on the output target. This is so as standardize the CCI values included in stream data outputted via data IO device 100. As mentioned above, stream data may include different types of CCI, with table 151 having CGMS, APS (Analog Protection System) and so forth written therein, for example.

If conversion is performed using conversion table 151 in the case of the CCI, CGMS and APS values of stream data inputted to data IO device 100 being respectively “01”, “10” and “01”, and the output target being DVD-RAM, for example, information indicating a CGMS value of “01” and an APSTB value of “10” is included in the stream data. Note that while the section of table 151 in FIG. 4 only shows the corresponding conversion values for the CCI value “01”, the corresponding conversion values for the CCI values “10” and “11” are recorded in the section of table 151 not depicted. Note also that MV in table 151 denotes Macrovision.

Operations of Data IO Device

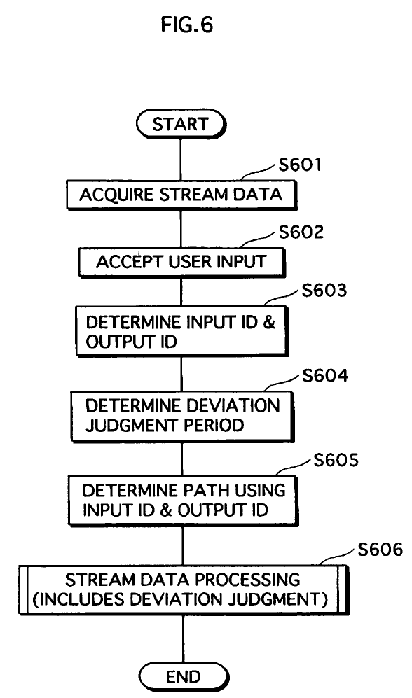

The overall operations of data IO device 100 are described next, while referring to the FIG. 6 flowchart.

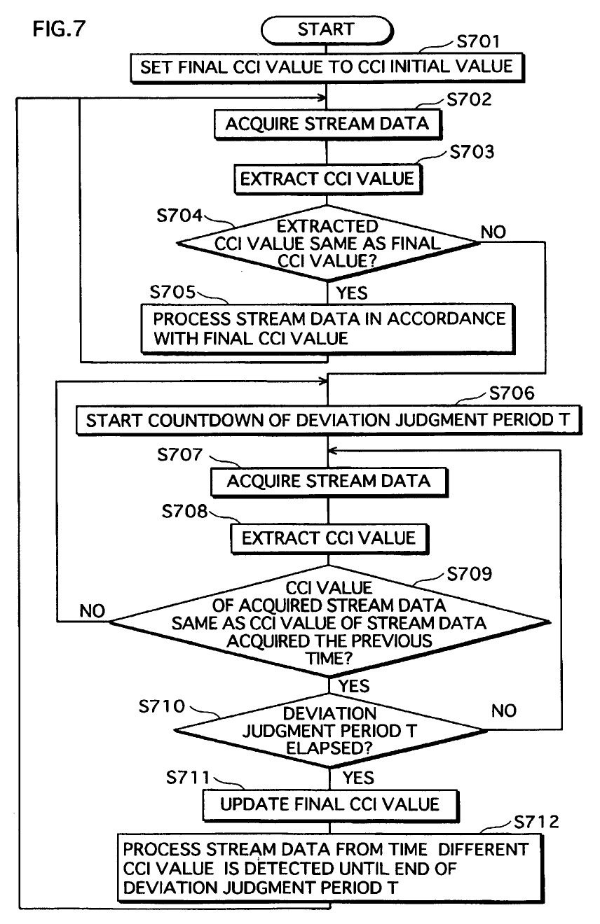

Firstly, acquiring unit 120 acquires stream data (step S601). User-input reception unit 111 accepts a user input relating to where to transfer acquired stream data (step S602). Stream control unit 110 reads the input ID corresponding to the input source of the acquired stream data from input ID table 112, and the output ID corresponding to the output target device indicated by the user input from output ID table 113 (step S603), and outputs the read input ID and output ID to path selection unit 130. Stream control unit 110 reads a deviation judgment period from judgment period table 114 according on the type of acquired stream data (step S604). Path selection unit 130, having received the read input ID and output ID, determines an output path for the stream data (step S605). Stream control unit 110 outputs the read deviation judgment period to deviation judgment unit 140, which performs stream data processing (includes deviation judgment) in accordance with the received deviation judgment period (step S606). A detailed description of this stream data processing including the deviation judgment is given below using the FIG. 7 flowchart. The above operations are performed until the end of data acquisition.

The following description relates to the stream data processing (includes deviation judgment) of step S606 in FIG. 6 performed by deviation judgment unit 140, with reference to the FIG. 7 flowchart.

Firstly, deviation judgment unit 140 provisionally sets the final CCI value to the CCI initial value according to the type of acquired stream data (step S701). As mentioned above, the initial value is the CCI value provisionally assigned to the final CCI value of stream data when recording stream data, in order to deal with devices that will not record unless the CCI has been finalized. Acquiring unit 120 acquires stream data (step S702), and CCI extraction unit 141 extracts the CCI value of the acquired stream data (step S703).

Deviation judgment unit 140 compares the CCI value with the final CCI value and if the same (step S704=YES), various processing is performed, including the confirming or erasing of tentatively recorded stream data in accordance with the final CCI value, and if necessary, the changing of the CCI value to be included in stream data (step S705). For example, if the CCI is finalized as COPY ONCE, data IO device 100 changes the CCI to COPY NEVER and has the changed CCI included in the stream data tentatively recorded by the output target device to thus confirm the recording. On the other hand, if finalized as COPY NEVER, data IO device 100 prohibits recording of the stream data, and if finalized as COPY FREELY, data IO device 100 has CCI indicating COPY FREELY included in the tentatively recorded stream data to thus confirm the recording. If the output target device is a monitor, data IO device 100 controls the monitor to display the stream data or prohibits display, depending on the CCI.

The processing of steps S702 to S705 is repeated as long as the CCI value remains unchanged. If the extracted CCI value is different to the final CCI value (step S704=NO), deviation judgment unit 140 starts counting down a deviation judgment period T from the point at which the different CCI value is detected (step S706).

Acquiring unit 120 then acquires the next piece of stream data (step S707). CCI extraction unit 141 extracts the CCI value included in this next piece of acquired stream data (step S708), and deviation judgment unit 140 judges whether the extracted CCI value is the same as the CCI value of the previous piece of acquired stream data (step S709). If not the same (step S709=NO), unit 140 returns to step S706, restarts the countdown of deviation judgment period T, and proceeds to the following steps. If the CCI values are the same (step S709=YES), unit 140 judges whether deviation judgment period T has elapsed (step S710). If yet to elapse (step S710=NO), unit 140 returns to step S707, acquires the next piece of stream data, and proceeds to the following steps.

If deviation judgment period T has elapsed (step S710=YES), deviation judgment unit 140 updates the final CCI value to the identical CCI value extracted during deviation judgment period T (step S711). Data IO device 100 then processes all of the stream data acquired from the point at which the different CCI value was detected at step S704 until the point at which deviation judgment period T elapsed, in accordance with the CCI values judged to be the same at step S709 (step S712). The processing then returns to step S702 to acquire the next piece of stream data, and proceeds to the following steps.

This processing is performed until the end of data acquisition.

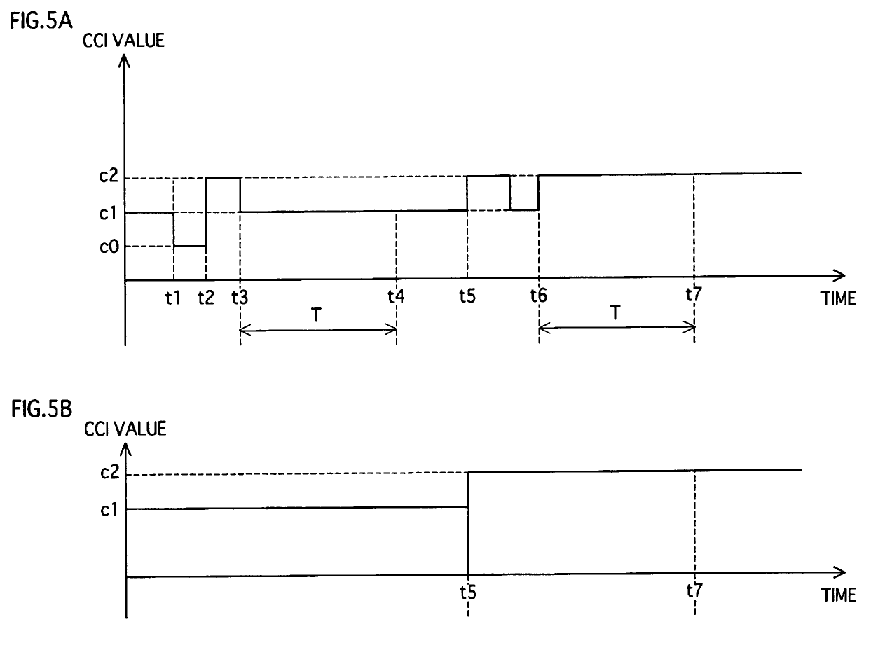

Taking the FIG. 5A graph as an example, the deviation judgment will now be described in detail in terms of the relation between CCI values and time, while referring back to the FIG. 7 flowchart. FIG. 5A show an exemplary fluctuation in CCI values extracted by CCI extraction unit 141. The deviation judgment is described here in terms of the change in CCI values shown in FIG. 5A. In the FIGS. 5A and 5B graphs, CCI values and time are shown on the vertical and horizontal axes, respectively. Also, to facilitate comprehension, the CCI values are written as c0, c1 and c2, while the time segments are written as t1, t2, . . . , t7.

Firstly, deviation judgment unit 140 sets the final CCI value to c1, which in the given example is the initial value of CCI included in stream data (step S701). Since there is no change in the CCI values included in the stream data acquired until time t1, this stream data is processed sequentially in accordance with c1 (steps S702-S705). However, the CCI value changes from c1 to c0 at time t1, so deviation judgment unit 140, having detected this change (step S704=NO), starts counting down deviation judgment period T for stream data acquired from the point at which the change is detected (step S706). Since the CCI value remains unchanged until time t2, deviation judgment unit 140 repeats the deviation judgment for this period and waits for deviation judgment period T to elapse (steps S707-S710). However, having detected a change in the CCI value from c0 to c2 at time t2 prior to the elapse of deviation judgment period T (step S709=NO), unit 140 starts measuring deviation judgment period T again from time t2 (step S706). Having again detected a change in the CCI value from c2 to c1 at time t3 prior to the elapse of deviation judgment period T (step S709=NO), unit 140 starts measuring of deviation judgment period T again from time t3 (step S706).

Since deviation judgment period T measured from time t3 elapses without any change in the CCI value (steps S707-S710), deviation judgment unit 140 finalizes the CCI value from times t1 to t4 at c1 (step S711), and data IO device 100 performs stream data processing in accordance with this finalized CCI value (step S712). After time t4, unit 140 merely monitors the CCI values of stream data acquired sequentially from time t4 without measuring deviation judgment period T, and as long as the CCI values of the acquired stream data remain the same, data IO device 100 processes stream data as it is acquired (steps S702-S705).

Having detected that the CCI value has again fluctuated from c1 to c2 at time t5 (step S704=NO), deviation judgment unit 140 starts measuring deviation judgment period T (step S706). The CCI value changes again prior to time t6 before deviation judgment period T has elapsed. Having again detected a change in the CCI value from c1 to c2 at time t6, unit 140 starts counting down deviation judgment period T from time t6 (step S706). Then, having judged that the CCI values are all the same for the duration of deviation judgment period T from times t6 to t7 (step S707-S710), unit 140 finalizes the CCI value of stream data acquired from times t5 to t7 at c2 (step S711), and data IO device 100 processes the stream data acquired during this period (t5-t7) in accordance with the final CCI value c2 (step S712). This processing is performed until the end of data acquisition.

FIG. 5B is a graph showing the transition in CCI values after deviation judgment unit 140 has corrected for fluctuations in the CCI value of acquired stream data shown in FIG. 5A. CCI values finalized for stream data acquired from the start of data acquisition until time t7 is shown. As shown in FIG. 5A, the CCI value of stream data acquired up to time t5 is finalized at c1, while CCI value of stream data acquired from times t5 to time t7 is finalized at c2.

Related Matters

While a data IO device 100 pertaining to the present invention is described above in accordance with a preferred embodiment, the present invention is by no means limited to this embodiment. Possible variations of the preferred embodiment are described below.
(1) While the preferred embodiment is described in terms of stream data being received from an external input device and outputted to an external output device, a configuration in which data IO device 100 contains a tuner for receiving broadcasts, and a DVD drive, BD drive or similar device capable of reading and writing data is possible. In this case, data IO device 100 also performs the recording and/or other processing.
(2) While the preferred embodiment is described in terms of inputs and outputs corresponding one-to-one, this need not be the case. It is possible to specify two or more output target devices for outputting the same stream data to. Given that the deviation judgment is perform on the same type of stream data at any one time, stream data is processed in accordance with the finalized CCI irrespective of the output target, and outputted to the device(s) specified by the user.
(3) In the preferred embodiment, CCI for the time period from times t5 to t6 in FIG. 5A is finalized at the CCI value (c2) included in stream data acquired during the subsequent period from times t6 to t7. However, all CCI values included in stream data acquired from times t5 to t6 may be temporarily stored, and the final CCI value of this stream data determined to be whichever of the final CCI value before time t5 (c1) and the final CCI value after time t6 (c2) has the greatest number in the stored CCI values.
(4) While data IO device 100 in the preferred embodiment is a computer containing a CPU, ROM and RAM, data IO device 100 may be realized merely by hardware for executing the functions executed by the various components described above. Alternatively, data IO device 100 may be realized as all or part of an LSI (large scale integration) or VLSI (very large scale integration) etc., or as a plurality of LSIs etc., or by combining one or a plurality of LSIs with other types of circuits etc.
(5) In the preferred embodiment, data IO device 100 firstly compares the CCI values of acquired stream data with the CCI initial value from the start of the data acquisition, and processes stream data in accordance with the CCI initial value if the same. However, the deviation judgment as to whether all CCI values included in stream data acquired within the deviation judgment period are the same may be commenced together with the start of data acquisition. In this case, stream data acquired from the start of data acquisition until the first time that all CCI values during the deviation judgment period are judged to be the same is processed in accordance with the CCI value judged to be the same.
(6) While stream data in the preferred embodiment includes CCI, in the case of CCI not being included, data IO device 100 may output stream data after having CCI indicating COPY NEVER or COPY ONCE included therein. This enables the wide circulation of stream data to be prevented.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A data IO device for acquiring stream data that includes copy control information and outputting the stream data after finalizing a content of the copy control information, comprising:
an acquiring unit operable to sequentially acquire stream data that includes copy control information;
a sameness judging unit operable to judge whether all stream data acquired within a predetermined time period includes a same copy control information; and
a processing unit operable, if the sameness judging unit judges in the affirmative, to process all stream data acquired during the predetermined time period in accordance with the same copy control information.

2. The data IO device of claim 1, wherein if judged during the predetermined judgment period that copy control information included in an n^{th} piece of acquired stream data differs from copy control information included in an n−1^{th} piece of acquired stream data, the sameness judging unit restarts the sameness judgment from a point at which the negative judgment is made and judges whether stream data acquired from the n^{th} piece onward includes a same copy control information.

3. The data IO device of claim 2 further comprising:
a difference judging unit operable, if the sameness judging unit judges in the affirmative, to judge whether stream data sequentially acquired after the stream data acquired within the predetermined time period includes copy control information that differs from the same copy control information, wherein
the processing unit continues to process, in accordance with the same copy control information, stream data acquired after the sameness judging unit has judged in the affirmative, until a point at which the difference judging unit judges in the affirmative.

4. The data IO device of claim 1, wherein the processing unit processes all stream data acquired from a start of the data acquisition until a point at which the sameness judging unit first judges that all stream data acquired during the predetermined time period includes the same copy control information, in accordance with the same copy control information.

5. The data IO device of claim 3, wherein
the sameness judging unit newly judges, from the point at which the difference judging unit judges in the affirmative, whether all stream data acquired within the predetermined time period includes a same copy control information, and
the processing unit processes all stream data acquired from the point at which the difference judging unit judges in the affirmative until a point at which the sameness judging unit newly judges in the affirmative, in accordance with the same copy control information.

6. The data IO device of claim 1, wherein there are plural types of stream data,
the data IO device further comprises:
a time-period storage unit storing a plurality of predetermined time periods in one-to-one correspondence with the types of stream data; and
a time-period reading unit operable to read from the time-period storage unit a predetermined time period corresponding to the type of acquired stream data, and
the sameness judging unit judges, based on the type of acquired stream data, whether all stream data acquired within the predetermined time period read by the time-period reading unit includes a same copy control information.

7. The data IO device of claim 3, wherein there are plural types of stream data,
the data IO device further comprises:
an initial-value storage unit storing a plurality of initial values for copy control information in one-to-one correspondence with the types of stream data; and
an initial-value reading unit operable to read from the initial-value storage unit an initial value corresponding to the type of acquired stream data, and
the difference judging unit further judges whether stream data sequentially acquired from a start of the data acquisition includes copy control information that differs from the initial value.

8. The data IO device of claim 6 further comprising:
an ID storage unit storing one or more input IDs in correspondence with the types of acquired stream data, and one or more output IDs in one-to-one correspondence with one or more output target devices to which stream data is to be outputted;
a ID reading unit operable to read from the ID storage unit an input ID, based on the type of acquired stream data, and an output ID corresponding to an output target device determined by a user input; and
a path selection unit operable to select an output path for stream data, based on the read input ID and output ID.

9. The data IO device of claim 1, wherein the processing performed by the processing unit involves (i) controlling an output target device to record stream data with copy control information indicating COPY FREELY included therein if the same copy control information indicates COPY FREELY, (ii) controlling the output target device to record stream data with copy control information changed to indicate COPY NEVER included therein if the same copy control information indicates COPY ONCE, and (iii) prohibiting the output target device from recording stream data if the same copy control information indicates COPY NEVER.

10. A data IO method for acquiring stream data that includes copy control information and outputting the stream data after finalizing a content of the copy control information, comprising the steps of:
sequentially acquiring stream data that includes copy control information;
judging whether all stream data acquired within a predetermined time period includes a same copy control information; and
processing all stream data acquired during the predetermined time period in accordance with the same copy control information, if judged in the affirmative.

11. A data IO computer program for acquiring stream data that includes copy control information and outputting the stream data after finalizing a content of the copy control information, comprising the steps of:
sequentially acquiring stream data that includes copy control information;
judging whether all stream data acquired within a predetermined time period includes a same copy control information; and
processing all stream data acquired during the predetermined time period in accordance with the same copy control information, if judged in the affirmative.
